(19) United States
(12) Patent Application Publication
(10) Pub. No.: US 2015/0067146 A1
(43) Pub. Date: Mar. 5, 2015

(54) CUSTOM CORRELATION OF A DISTRIBUTED BUSINESS TRANSACTION

(71) Applicant: AppDynamics, Inc., San Francisco, CA (US)

(72) Inventors: Todd Raker, San Francisco, CA (US); Suraj Puvvada, San Francisco, CA (US); Manoj Acharya, San Francisco, CA (US); Vinay Srinivasaiah, San Francisco, CA (US)

(73) Assignee: AppDynamics, Inc., San Francisco, CA (US)

(21) Appl. No.: 14/018,349

(22) Filed: Sep. 4, 2013

(51) Int. Cl. H04L 12/26

(52) U.S. Cl. CPC H04L 43/04
USPC 709/224

(57) ABSTRACT

A mechanism is provided for customizing communication of correlation data between servers using a custom or proprietary communication protocol. The system may modify a payload transmitted between servers to include monitoring parameters. The payload may be modified by expanding a portion of the payload or otherwise inserting data into the payload. The portion may include a header, footer, an additional property, a field, or other portion of the header. A mechanism may detect both outgoing calls and incoming requests to either modify the request with the payload or retrieve the payload from the request. The configuration preferences received from a user may be used to process the detected calls and modify a payload at a designed portion suitable to be expanded. Once sent, the configuration parameters may be used by a recipient server to detect the request with the modified payload and retrieve the monitoring parameter. The monitoring parameter may be used to correlate distributed transactions that occur over a set of servers which communicate with non-standard protocols.

### BACKGROUND OF THE INVENTION

The World Wide Web has expanded to provide web services faster to consumers. Web services may be provided by a web application which uses one or more services to handle a transaction. The applications may be distributed over several machines, making the topology of the machines that provides the service more difficult to track and monitor.

Monitoring a web application helps to provide insight regarding bottle necks in communication, communication failures and other information regarding performance of the services that provide the web application. Monitoring systems are designed to work with standard protocols of hyper text transfer protocol (HTTP) and Java monitoring service (JMS). These standard protocols have standard commands and APIs that make monitoring basic application function relatively straightforward.

As additional entities develop a presence on the web and other networks, it is vital that they ensure their applications meet the standards of service expected by consumers. Some of these additional entities utilize non-standard protocols in providing their applications. These non-standard protocols are not compatible with monitoring systems that work with specific protocols, such as HTTP and JMS protocols.

There is a need in the art for application service monitoring which may monitor web applications utilizing non-standard protocols.

### SUMMARY OF THE CLAIMED INVENTION

A mechanism is provided for customizing communication of correlation data between servers using a custom or proprietary communication protocol. The system may modify a payload transmitted between servers to include monitoring parameters. The payload may be modified at any of several portions of the payload, such as for example by modifying an expandable portion of the payload, adding data to a non-expandable portion, and modifying the payload in another manner. The monitoring parameter may be included in the modified portion. The modified portion may include a header, footer, an additional property, a field, or other portion of the header. A mechanism may detect both outgoing calls and incoming requests to either modify the request with the payload or retrieve the payload from the request. The configuration preferences received from a user may be used by a first server to process the detected calls and modify a payload at a designed portion suitable to be expanded. Once sent, the configuration parameters may be used by a recipient server to detect the request with the modified payload and retrieve the monitoring parameter. The monitoring parameter may be used to correlate distributed transactions that occur over a set of servers which communicate with non-standard protocols, such as protocols other than HTTP and JMS.

An embodiment may include a method for monitoring a business transaction. The method may begin with receiving an identification of a portion of a payload to be transmitted from a first application to a second application. An agent may automatically modify a call from the first application to include a monitoring parameter in the identified portion of the payload. The call may be transmitted with the monitoring parameter.

An embodiment may include a method for monitoring a business transaction which begins by receiving a call from a remote application. It may be determined that the call matches configuration data. A monitoring parameter may be retrieved from an identified portion of the call. The call with the monitoring parameter may then be processed.

An embodiment may include a system for monitoring a business transaction. The system may include a processor, a memory and one or more modules stored in memory and executable by the processor. When executed, the one or more modules may receive an identification of a portion of a payload to be transmitted from a first application to a second application, automatically modify by an agent a call from the first application to include a monitoring parameter in the identified portion of the payload and transmit the call with the monitoring parameter.

### BRIEF DESCRIPTION OF THE DRAWINGS

FIG. 1 is an exemplary system for monitoring business transactions.

FIG. 2 is a block diagram of an exemplary application server.

FIG. 3 is an exemplary method for monitoring a business transaction using a custom protocol.

FIG. 4 is an exemplary method for receiving a monitoring configuration.

FIG. 5 is an exemplary method for transmitting runtime data.

FIG. 6 is an exemplary method for processing and responding to a received call.

FIG. 7 is a block diagram of a computing device for implementing the present invention.

FIG. 8 is a block diagram of an exemplary mobile device for implementing the present technology.

### DETAILED DESCRIPTION

The present technology may provide a mechanism for customizing communication of correlation data between servers using a custom or proprietary communication protocol. The present system may modify a payload transmitted between servers to include monitoring parameters. The payload may be modified by expanding a portion of the payload, adding data to a non-expandable portion of the payload, or otherwise modifying the payload. The monitoring parameter may be included in the modified portion. The modified portion may include a header, footer, an additional property, a field, or other portion of the header.

Embodiments of the invention may include a mechanism to detect both outgoing calls and incoming requests to either modify the request with the payload or retrieve the payload from the request. Configuration preferences may be received from a user. The configuration preferences may be used by a first server to process the detected calls and modify a payload at a designed portion suitable to be expanded or otherwise modified. Once sent, the configuration parameters may be used by a recipient server to detect the request with the modified payload and retrieve the monitoring parameter. The monitoring parameter may be used to correlate distributed transactions that occur over a set of servers which communicate with non-standard protocols, such as protocols other than HTTP and JMS.

Though embodiments of the invention may be discussed with respect to a modified portion of a payload, the references to “expandable” portions are merely for purposes of discussion. The present invention may be implemented with both expandable and non-expandable payloads.

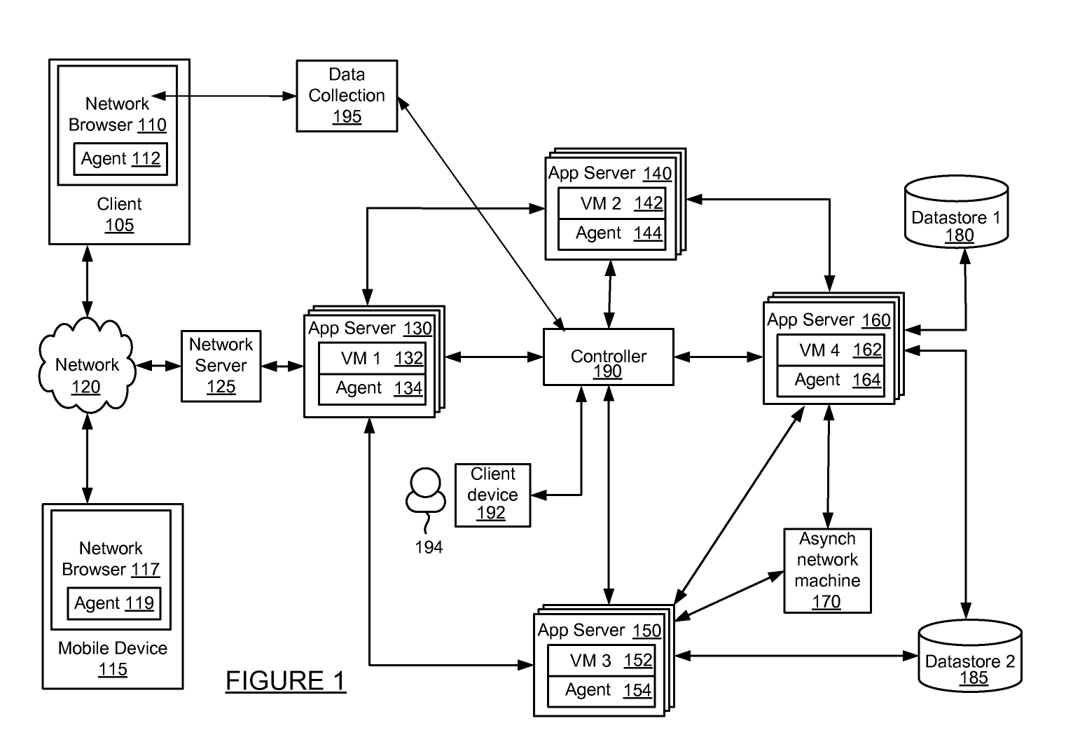

FIG. 1 is an exemplary system for monitoring business transactions. System 100 of FIG. 1 includes client device 105, mobile device 115, network 120, network server 125, application servers 130, 140, and 150, data collection server 160, asynchronous network machine 170, data stores 180 and 185, controller 190, and data collection server 195.

Client device 105 may include network browser 110 and be implemented as a computing device, such as for example a laptop, desktop, workstation, or some other computing device. Network browser 110 may be a client application for viewing content provided by an application server, such as application server 130 via network server 125 over network 120.

Network browser 110 may include agent 112. Agent 112 may be embedded, installed or otherwise provided on network browser 110 and/or client 105, for example as a network browser add-on, downloading the agent to the network browser as part of HTML, or in some other manner. Agent 112 may be executed to monitor network browser 110, the operation system of client 105, and any other application, API, or other component of client 105. Agent 112 may determine network browser navigation timing metrics, access browser cookies, and transmit data to data collection 160, controller 190, or another device. Agent 112 may perform other operations related to monitoring a request at client 105 as discussed herein.

Mobile device 115 is connected to network 120 and may be implemented as a portable device suitable for sending and receiving content over a network, such as for example a mobile phone, smart phone, tablet computer or other portable device. Both client device 105 and mobile device 115 may include hardware and/or software configured to access a web service provided by network server 125.

Mobile device 115 may include network browser 117 and an agent 119. Agent 119 may reside in and/or communicate with network browser 117, as well as communicate with other applications, an operating system, APIs and other hardware and software on mobile device 115. Agent 119 may have similar functionality as that described herein for agent 112 on client 105, and may repot data to data collection server 160 and/or controller 190.

Network 120 may facilitate communication of data between different servers, devices and machines. The network may be implemented as a private network, public network, intranet, the Internet, a cellular network, Wi-Fi network, VoIP network, or a combination of one or more these networks.

Network server 125 is connected to network 120 and may receive and process requests received over network 120. Network server 125 may be implemented as one or more servers implementing a network service. When network 120 is the Internet, network server 125 may be implemented as a web server. In some embodiments, network server 125 and application server 130 may be a single server, or include multiple machines that each implement a network server and an application server.

Application server 130 may communicate with network server 125, application servers 140 and 150, controller 190 and other servers and devices of the system of FIG. 1. Application server 130 may also communicate with other machines and devices (not illustrated in FIG. 1). Application server 130 may host an application or portions of a distributed application and include a virtual machine 132, agent 134, and other software modules. Application server 130 may be implemented as one server or multiple servers as illustrated in FIG. 1.

Application servers 130-170 may implement a communication protocol other than a standard protocol such as HTTP and JMS. The non-standard protocol may be proprietary and unique to the distributed system implemented by servers 130-170 and not compatible with HTTP and JMS. As such, the non-standard protocol may not be used with commands associated with common protocols such as HTTP and JMS.

Virtual machine 132 may be implemented by code running on one or more application servers. The code may implement computer programs, modules and data structures to implement a virtual machine mode for executing programs and applications. In some embodiments, more than one virtual machine 132 may execute on an application server 130. A virtual machine may be implemented as a Java Virtual Machine (JVM). Virtual machine 132 may perform all or a portion of a business transaction performed by application servers comprising system 100. A virtual machine may be considered one of several services that implement a web service.

In embodiments, applications may execute on servers in program containers other than a virtual machine. For example, applications may be executed in PHP on any of servers 130-160.

Virtual machine 132 may be instrumented using byte code insertion, or byte code instrumentation, to modify the object code of the virtual machine. The instrumented object code may include code used to detect calls received by virtual machine 132, calls sent by virtual machine 132, and communicate with agent 134 during execution of an application on virtual machine 132. Alternatively, other code may be byte code instrumented, such as code comprising an application which executes within virtual machine 132 or an application which may be executed on application server 130 and outside virtual machine 132.

Agent 134 on application server 130 may be installed on application server 130 by instrumentation of object code, downloading the agent to the server, or in some other manner. Agent 134 may be executed to monitor application server 130, monitor virtual machine 132, and communicate with byte instrumented code on application server 130, virtual machine 132 or another application on application server 130. Agent 134 may detect operations such as receiving calls and sending requests by application server 130 and virtual machine 132. Agent 134 may receive data from instrumented code of the virtual machine 132, process the data and transmit the data to controller 190. Agent 134 may perform other operations related to monitoring virtual machine 132 and application server 130 as discussed herein. For example, agent 134 may identify other applications, share business transaction data, aggregate detected runtime data, and other operations.

Agent 134 may create a request identifier for a request received by server 130. The request identifier may be sent to client 105 or mobile device 115, whichever device sent the request. In embodiments, the request identifier may be created when a data is collected and analyzed for a particular business transaction. Additional information regarding collecting data for analysis is discussed in U.S. patent application no. U.S. patent application Ser. No. 12/878,919, titled “Monitoring Distributed Web Application Transactions,” filed on Sep. 9, 2010, U.S. patent application Ser. No. 13/189,360, titled “Automatic Capture of Diagnostic Data Based on Transaction Behavior Learning,” filed on Jul. 22, 2011, and U.S. patent application Ser. No. 13/365,171, titled “Automatic Capture of Detailed Analysis Information for Web Application Outliers with Very Low Overhead,” filed on Feb. 2, 2012, the disclosures of which are incorporated herein by reference.

Each of application servers 140, 150 and 160 may include an application and an agent. Each application may run on the corresponding application server or a virtual machine. Each of virtual machines 142, 152 and 162 on application servers 140-160 may operate similarly to virtual machine 132 and host one or more applications which perform at least a portion of a distributed business transaction. Agents 144, 154 and 164 may monitor the virtual machines 142-162, collect and process data at runtime of the virtual machines, and communicate with controller 190. The virtual machines 132, 142, 152 and 162 may communicate with each other as part of performing a distributed transaction. In particular each virtual machine may call any application or method of another virtual machine.

Asynchronous network machine 170 may engage in asynchronous communications with one or more application servers, such as application server 150 and 160. For example, application server 150 may transmit several calls or messages to an asynchronous network machine. Rather than communicate back to application server 150, the asynchronous network machine may process the messages and eventually provide a response, such as a processed message, to application server 160. Because there is no return message from the asynchronous network machine to application server 150, the communications between them are asynchronous.

Application servers 130-170 may implement a communication protocol other than a standard protocol such as HTTP and JMS. The non-standard protocol may be proprietary and unique to the distributed system implemented by servers 130-170 and not compatible with HTTP and JMS. As such, the non-standard protocol may not be used with commands associated with common protocols such as HTTP and JMS.

Data stores 180 and 185 may each be accessed by application servers such as application server 150. Data store 185 may also be accessed by application server 150. Each of data stores 180 and 185 may store data, process data, and return queries received from an application server. Each of data stores 180 and 185 may or may not include an agent.

Controller 190 may control and manage monitoring of business transactions distributed over application servers 130-160. Controller 190 may receive runtime data from each of agents 134-164, associate portions of business transaction data, communicate with agents to configure collection of runtime data, and provide performance data and reporting through an interface. The interface may be viewed as a web-based interface viewable by mobile device 115, client device 105, or some other device. In some embodiments, a client device 192 may directly communicate with controller 190 to view an interface for monitoring data.

In some embodiments, controller 190 may receive runtime data, including data associated with monitoring client requests at client 105 and mobile device 115, from data collection server 160. In some embodiments, controller 190 may receive runtime data from each of agents 112, 119, 134, 144 and 154. Controller 190 may associate portions of business transaction data with other portions of business transaction data and virtual machines, applications, and other nodes and hardware that the business transaction data is generated from monitoring, communicate with agents to configure collection of runtime data, and provide performance data and reporting through an interface. Performance data may include metrics, errors, and other data and events which may be captured and/or generated during the monitoring of a distributed transaction. The interface may be viewed as a web-based interface viewable by client device 192, which may be a mobile device, client device, or any other platform for viewing an interface provided by controller 190.

Controller 190 may install an agent into one or more virtual machines and/or application servers 130. Controller 190 may receive correlation configuration data, such as an object, a method, or class identifier, from a user through client device 192.

Data collection server 195 may communicate with client 105, 115 (not shown in FIG. 1), and controller 190, as well as other machines in the system of FIG. 1. Data collection server 195 may receive data associated with monitoring a client request at client 105 (or mobile device 115) and may store and aggregate the data. The stored and/or aggregated data may be provided to controller 190 for reporting to a user.

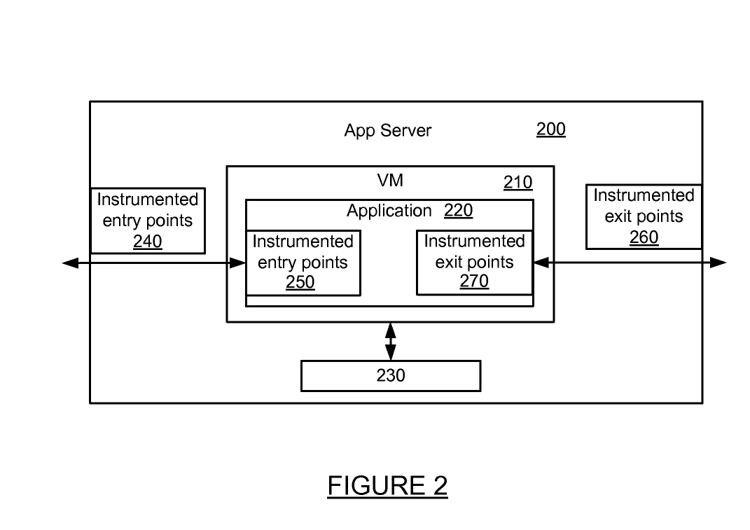

FIG. 2 is a block diagram of an exemplary application server. The application server in FIG. 2 provides more information for each application server of system 100 in FIG. 1. Application server 200 of FIG. 2 includes a virtual machine 210, application 220 executing on the virtual machine, and agent 230. Virtual machine 210 may be implemented by programs and/or hardware. For example, virtual machine 134 may be implemented as a JAVA virtual machine. Application 220 may execute on virtual machine 210 and may implement at least a portion of a distributed application performed by application servers 130-160. Application server 200, virtual machine 210 and agent 230 may be used to implement any application server, virtual machine and agent of a system such as that illustrated in FIG. 1.

Application server 200 and application 220 can be instrumented via byte code instrumentation at exit and entry points. An entry point may be a method or module that accepts a call to application 220, virtual machine 210, or application server 200. An exit point is a module or program that makes a call to another application or application server. As illustrated in FIG. 2, an application server 200 can have byte code instrumented entry points 240 and byte code instrumented exit points 260. Similarly, an application 220 can have byte code instrumentation entry points 250 and byte code instrumentation exit points 270. For example, the exit points may include calls to JDBC, JMS, HTTP, SOAP, and RMI. Instrumented entry points may receive calls associated with these protocols as well. In some instances, portions of an application or other program may be monitored without instrumenting byte code, but rather by adding code to the exit points, entry points, and other portions of the program. For example, for applications implemented in PHP, the exit and entry points may have code added which informs an agent when they are executed or called. As such, an agent can detect when an entry point is called or an exit point is called in PHP based programs.

Agent 230 may be one or more programs that receive information from an entry point or exit point. Agent 230 may process the received information, may retrieve, modify and remove information associated with a thread, may access, retrieve and modify information for a sent or received call, and may communicate with a controller 190. Agent 230 may be implemented outside virtual machine 210, within virtual machine 210, and within application 220, or a combination of these.

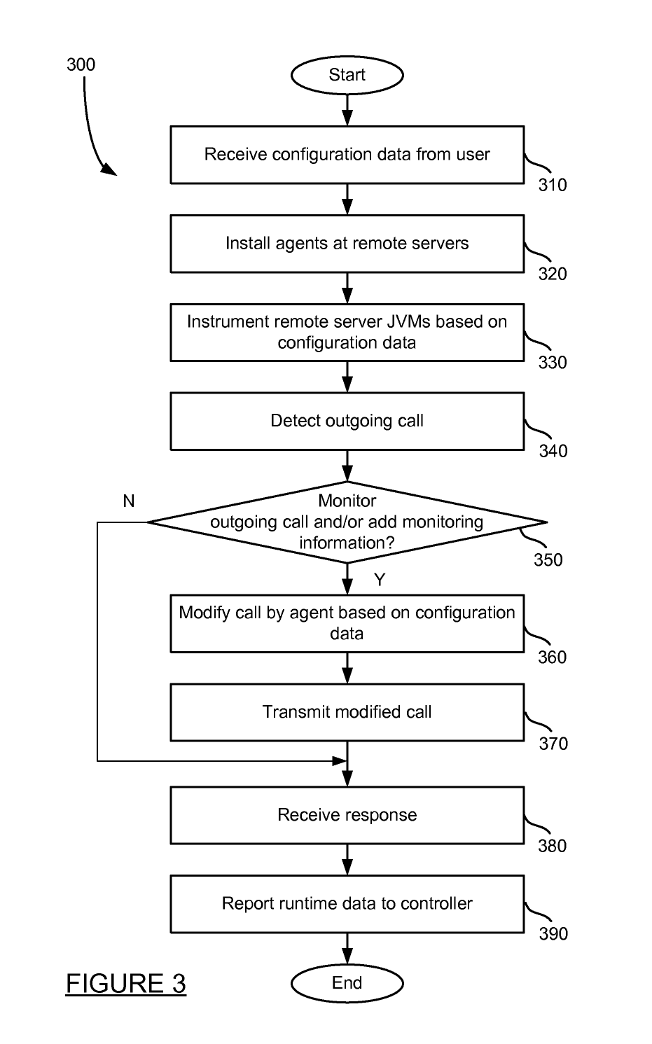

FIG. 3 is an exemplary method for monitoring a business transaction using a custom protocol. First, configuration data is received from a user at step 310. The configuration data may be used to identify a class, method, object, or other component to modify with a monitoring parameter.

The monitoring parameters may include an application identifier, transaction identifier, request identifier, call chain data, and other data. The application identifier may include a common identifier for all “nodes” that are being monitored and that belong to a logical entity, such as for example a single website. A transaction identifier may be a global unique identifier (GUID) that uniquely identifies a request being handling on a particular thread. The call chain data may identify the chain of applications or virtual machines that have processed the current business transaction thus far. For example, call chain data for a request received by VM4 from VM3 in the system of FIG. 1 may be “VM1-VM3-VM4.”

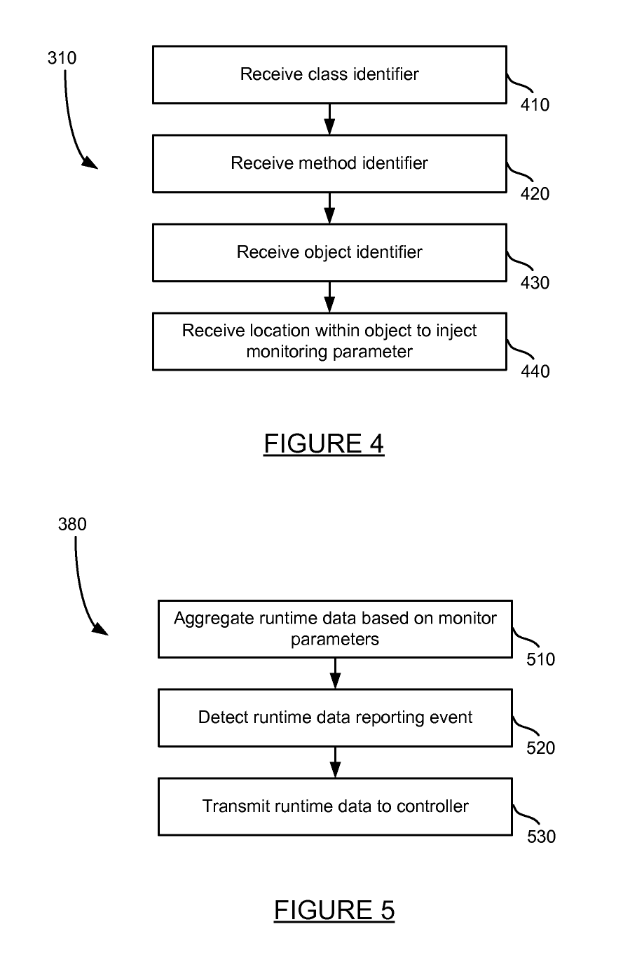

The data received at step 310 may be received through a graphical user interface provided by controller 190, client device 192, or other device. The configuration data may also be received in the form of an extended markup language (XML) file or other file that can be read and processed by an agent. The step of FIG. 310 is discussed in more detail below with respect to the method of FIG. 4.

Agents may be installed at remote servers at step 320. The agents may be installed by downloading the agents, instrumenting byte code at the remote servers, or other method. Remote server virtual machines may be instrumented based on the configuration data at step 330. The virtual machines may be instrumented to install code which when executed may detect a particular method, class, object, or other component to modify. The particular component may be modified, or otherwise detected, to insert a monitoring parameter within a payload of a particular call being made which is associated with the method, class or object.

An outgoing call is detected at step 340. The request to make an outgoing call may be detected by portions of code installed, for example by instrumenting the server byte code, on a virtual machine, by adding code to a PHP program or code segment, or other means. Once detected, a determination may be made as to whether the outgoing call may be monitored and/or monitoring information may be added to the call at step 350. The determination to monitor the call and/or add monitoring information to the outgoing call may be made based on the call protocol, type of call, the particular function of the call, user configuration, instructions received from a controller, agent logic, and other data or logic. If the outgoing call is not to be monitored or have monitoring information added to the call, the method of FIG. 3 continues to step 350. If the call is to be monitored or modified with monitoring information, the method of FIG. 3 continues to step 360.

The outgoing call may be intercepted and modified by an agent based on the configuration data at step 360. A call modification may include modifying a portion of the call payload to include a monitoring parameter. The call payload may be modified at any of several locations. For example, the call payload may be modified at an expandable portion identified in the configuration data (received at step 310 in FIG. 3). The call payload may also be modified at a non-expandable portion at which data may be added or overwritten, such as for example a payload field itself. The modified call may then be transmitted to the intended recipient at step 370.

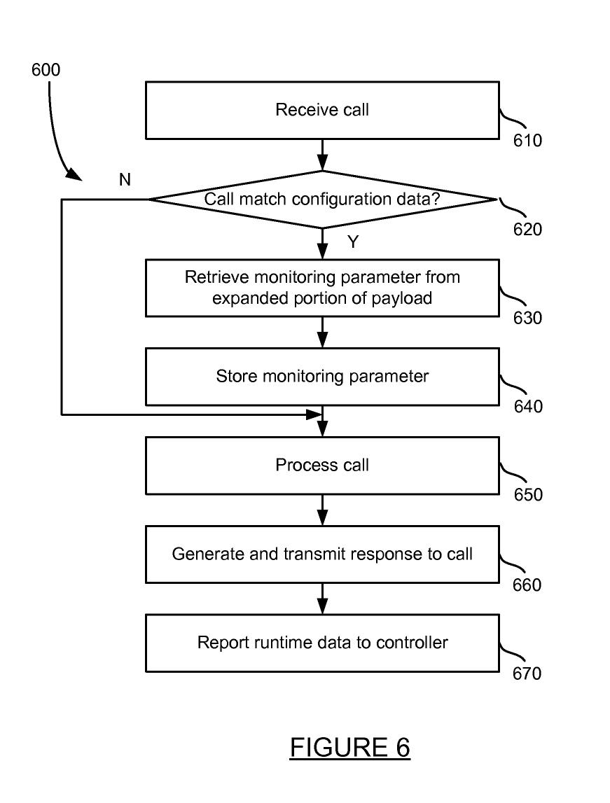

A response to the transmitted call is received at step 380. Runtime data may then be reported to a controller at step 390. Reporting of runtime data is discussed in more detail below with respect to the method of FIG. 5.

FIG. 4 is an exemplary method for receiving a monitoring configuration. The method of FIG. 4 begins with receiving a class identifier at step 410. The class identifier may be received as a particular class, data describing a number of classes, or in some other format. For example, a class may be identified as “all classes having a parameter of X” wherein X is a parameter identified by a user. A method may then be received at step 420. An object identifier may then be received at step 430. Identifiers for an object and method may also be described with specificity or more broadly to identify more than one object or method.

A location within an object to inject a monitoring parameter is then received at step 440. The location to inject the monitoring parameter may be any portion within an object, a method, or a class, including an expandable or other portion. The portion may include a header, a property which can be modified or added, a map or table, or some other component of a payload.

FIG. 5 is an exemplary method for transmitting runtime data. Runtime data may be aggregated at step 510. The runtime data collected by an agent may be aggregated based on monitoring parameters and averaged over a period of time, for example one minute.

Runtime data associated with the call may be stored as it is received. In some embodiments, the runtime data may indicate the response time for the call to complete. The runtime data may include timing information associated with a business transaction, call chain and other parameter information, and other data. An agent may receive or retrieve a timestamp corresponding to the beginning and the end of an application call, method call, and other operations. The time stamps may be stored with a business transaction identifier, application identifier, calling chain, and optionally other data for the request within a thread handling the call. Information may be cleared from the thread handling the call once the application server has completed processing of a request. Once the call is completed, a response time may be generated for the overall call as well as intervening calls to other applications.

A runtime data reporting event may be detected at step 520. The runtime reporting event may be any of several events, for example the expiration of a timer, a state of one or more resources of the application server reporting the runtime data, or another event. For example, an agent may be configured to report data periodically every minute, or some other time period. The agent may also adjust the reporting based on the load on the application server on which it resides, for example by waiting to report runtime data if not many processor cycles are available or reporting the runtime data more often is a large number of processing cycles are available.

Runtime data may then be transmitted to a controller 190 by an agent at step 530. The transmitted runtime data may include the aggregated runtime data determined at step 520. Runtime data may also include non-aggregated data, such as for example detailed request data collected during a diagnostics status “on” mode. Runtime data may be transmitted to a controller 190 periodically, for example every minute, based on an event such as a request from controller 190 or the end of a business transaction being monitored in detail, or some other event.

Controller 190 may receive data from one or more agents, process the data, and provide monitoring information regarding the system being monitored. When installed onto an application server, controller 190 may be initialized. Controller initialization may include loading information for application servers, such as identification information, loading transaction data, and other information.

FIG. 6 is an exemplary method for processing and responding to a received call. First, a call is received at step 610. A determination is then made as to whether the received call matches configuration data at step 620. The configuration data may indicate what portion of a payload may be extended to store a monitoring parameter. The call may match the configuration data if it contains payload with an extended portion as described by the configuration data. If the call does not match the configuration data, the method of FIG. 6 continues to step 650 where the call is processed as normal.

If the call does match the configuration data, then a monitoring parameter may be retrieved from the portion of the call payload at step 630. The retrieved monitoring parameter may then be stored at step 640. The monitoring data is used to start a continuing transaction. The continuing transaction may “continue” over several servers, machines, virtual machines, and so on, as a distributed transaction. By including the monitoring data in outgoing calls, and monitoring the outgoing calls at each server, data for the continuing or distributed transaction may be collected and reported to a controller. The controller may piece together the distributed portions of the transaction that occur at each server, machine, virtual machine, and so on, to determine localized and overall performance information for the continuing/distributed transaction.

Once the monitoring parameter is stored, the call may be processed as usual at step 650. A response to the call may be generated and transmitted at step 660. The response may be sent back to the virtual machine that transmitted the call to the present application. Runtime data is then reported to controller 670. Reporting runtime data to a controller is discussed in more detail with respect to the method of FIG. 5.

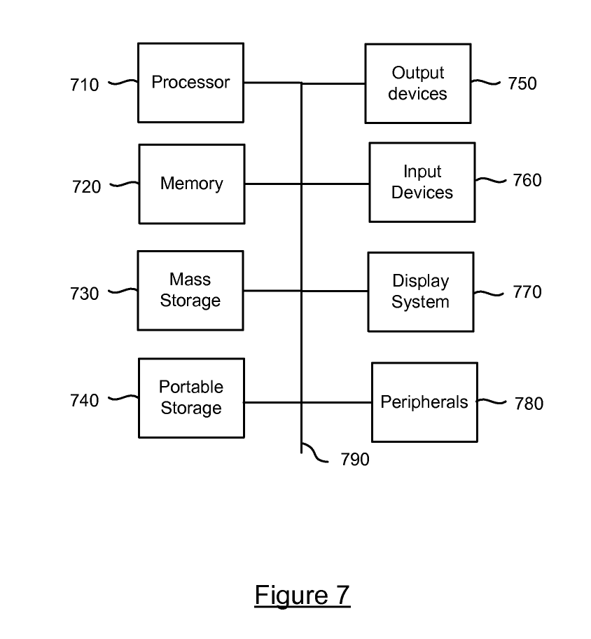

FIG. 7 illustrates an exemplary computing system 700 that may be used to implement an embodiment of the present invention. System 700 of FIG. 7 may be implemented in the contexts of the likes of clients 105 and 192, network server 125, application servers 130-160, and data stores 190-185. A system similar to that in FIG. 7 may be used to implement mobile device 115, but may include additional components such as an antenna, additional microphones, and other components typically found in mobile devices such as a smart phone or tablet computer.

The computing system 700 of FIG. 7 includes one or more processors 710 and memory 710. Main memory 710 stores, in part, instructions and data for execution by processor 710. Main memory 710 can store the executable code when in operation. The system 700 of FIG. 7 further includes a mass storage device 730, portable storage medium drive(s) 740, output devices 750, user input devices 760, a graphics display 770, and peripheral devices 780.

The components shown in FIG. 7 are depicted as being connected via a single bus 790. However, the components may be connected through one or more data transport means. For example, processor unit 710 and main memory 710 may be connected via a local microprocessor bus, and the mass storage device 730, peripheral device(s) 780, portable storage device 740, and display system 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 can store the system software for implementing embodiments of the present invention for purposes of loading that software into main memory 710.

Portable storage device 740 operates in conjunction with a portable non-volatile storage medium, such as a floppy disk, compact disk or Digital video disc, to input and output data and code to and from the computer system 700 of FIG. 7. The system software for implementing embodiments of the present invention may be stored on such a portable medium and input to the computer system 700 via the portable storage device 740.

Input devices 760 provide a portion of a user interface. Input devices 760 may include an alpha-numeric keypad, such as a keyboard, for inputting alpha-numeric and other information, or a pointing device, such as a mouse, a trackball, stylus, or cursor direction keys. Additionally, the system 700 as shown in FIG. 7 includes output devices 750. Examples of suitable output devices include speakers, printers, network interfaces, and monitors.

Display system 770 may include a liquid crystal display (LCD) or other suitable display device. Display system 770 receives textual and graphical information, and processes the information for output to the display device.

Peripherals 780 may include any type of computer support device to add additional functionality to the computer system. For example, peripheral device(s) 780 may include a modem or a router.

The components contained in the computer system 700 of FIG. 7 are those typically found in computer systems that may be suitable for use with embodiments of the present invention and are intended to represent a broad category of such computer components that are well known in the art. Thus, the computer system 700 of FIG. 7 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

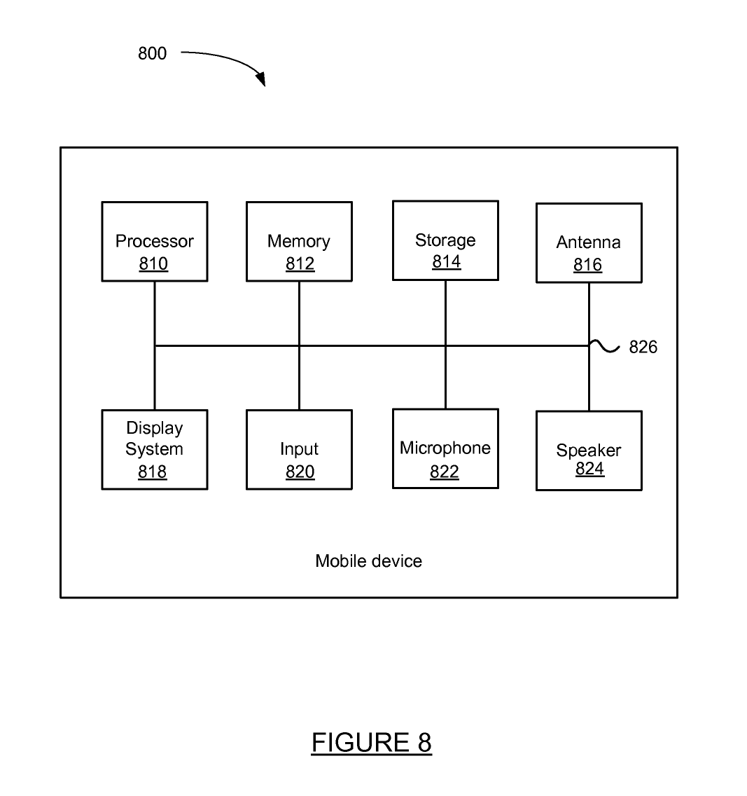

FIG. 8 is a block diagram of an exemplary mobile device for implementing the present technology. The system of FIG. 8 may be used to implement mobile device 115. Mobile device 800 of FIG. 8 includes one or more processors 810 and memory 812. Memory 812 stores, in part, programs, instructions and data for execution and processing by processor 810. The system 800 of FIG. 8 further includes storage 814, one or more antennas 816, a display system 818, inputs 820, one or more microphones 822, and one or more speakers 824.

The components shown in FIG. 8 are depicted as being connected via a single bus 826. However, the components 810-1024 may be connected through one or more data transport means. For example, processor unit 810 and main memory 812 may be connected via a local microprocessor bus, and storage 814, display system 818, input 820, and microphone 822 and speaker 824 may be connected via one or more input/output (I/O) buses.

Memory 812 may include local memory such as RAM and ROM, portable memory in the form of an insertable memory card or other attachment (e.g., via universal serial bus), a magnetic disk drive or an optical disk drive, a form of FLASH or PROM memory, or other electronic storage medium. Memory 812 can store the system software for implementing embodiments of the present invention for purposes of loading that software into main memory 810.

Antenna 816 may include one or more antennas for communicating wirelessly with another device. Antenna 816 may be used, for example, to communicate wirelessly via Wi-Fi, Bluetooth, with a cellular network, or with other wireless protocols and systems. The one or more antennas may be controlled by a processor 810, which may include a controller, to transmit and receive wireless signals. For example, processor 810 execute programs stored in memory 812 to control antenna 816 transmit a wireless signal to a cellular network and receive a wireless signal from a cellular network.

Display system 818 may include a liquid crystal display (LCD), a touch screen display, or other suitable display device. Display system 818 may be controlled to display textual and graphical information and output to text and graphics through a display device. When implemented with a touch screen display, the display system may receive input and transmit the input to processor 810 and memory 812.

Input devices 820 provide a portion of a user interface. Input devices 820 may include an alpha-numeric keypad, such as a keyboard, for inputting alpha-numeric and other information, a touch-screen, microphone, camera, buttons or switches, a trackball, stylus, or cursor direction keys.

Microphone 822 may include one or more microphone devices which transmit captured acoustic signals to processor 810 and memory 812. The acoustic signals may be processed to transmit over a network via antenna 816.

Speaker 824 may provide an audio output for mobile device 800. For example, a signal received at antenna 816 may be processed by a program stored in memory 812 and executed by processor 810. The output of the executed program may be provided to speaker 824 which provides audio. Additionally, processor 810 may generate an audio signal, for example an audible alert, and output the audible alert through speaker 824.

The mobile device system 800 as shown in FIG. 8 may include devices and components in addition to those illustrated in FIG. 8. For example, mobile device system 800 may include an additional network interface such as a universal serial bus (USB) port.

The components contained in the computer system 800 of FIG. 8 are those typically found in mobile device systems that may be suitable for use with embodiments of the present invention and are intended to represent a broad category of such mobile device components that are well known in the art. Thus, the computer system 800 of FIG. 8 can be a cellular phone, smart phone, hand held computing device, minicomputer, or any other computing device. The mobile device can also include different bus configurations, networked platforms, multi-processor platforms, etc. Various operating systems can be used including Unix, Linux, Windows, Macintosh OS, Google OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for monitoring a business transaction, comprising:
receiving an identification of a portion of a payload to be transmitted from a first application to a second application;
automatically modifying by an agent a call from the first application to include a monitoring parameter in the identified portion of the payload; and
transmitting the call with the monitoring parameter.

2. The method of claim 1, wherein the identified portion is an expandable portion.

3. The method of claim 1, wherein receiving an identification includes receiving a method identifier.

4. The method of claim 1, wherein the received identification identifies a payload.

5. The method of claim 1, wherein the portion includes a payload property.

6. The method of claim 1, wherein the portion includes an existing map payload.

7. The method of claim 1, further comprising instrumenting byte code of the application to insert code which detects the call that is modified.

8. The method of claim 1, wherein the identification is stored in an XML file, the agent modifying the call payload based on the XML file.

9. The method of claim 1, wherein the identification is received in a file generated in response to user input, the file generated from the user input.

10. The method of claim 9, wherein input is received through a user interface.

11. A method for monitoring a business transaction, comprising:
receiving a call from a remote application;
determining that the call matches configuration data;
retrieving a monitoring parameter from an identified portion of the call; and
processing the call with the monitoring parameter.

12. The method of claim 1, wherein the identified portion is an expandable portion.

13. The method of claim 1, wherein the portion includes a payload property.

14. The method of claim 1, wherein the portion includes an existing map payload.

15. A non-transitory computer readable storage medium having embodied thereon a program, the program being executable by a processor to perform a method for monitoring a business transaction, the method comprising:
receiving an identification of a portion of a payload to be transmitted from a first application to a second application;
automatically modifying by an agent a call from the first application to include a monitoring parameter in the identified portion of the payload; and
transmitting the call with the monitoring parameter.

16. The non-transitory computer readable storage medium of claim 15, wherein the identified portion is an expandable portion.

17. The non-transitory computer readable storage medium of claim 15, wherein the receiving an identification includes receiving a method identifier.

18. The non-transitory computer readable storage medium of claim 15, wherein the received identification identifies a payload.

19. The non-transitory computer readable storage medium of claim 15, wherein the portion includes a payload property.

20. The non-transitory computer readable storage medium of claim 15, wherein the portion includes an existing map payload.

21. The non-transitory computer readable storage medium of claim 15, the method further comprising instrumenting byte code of the application to insert code which detects the call that is modified.

22. The non-transitory computer readable storage medium of claim 15, wherein the identification is stored in an XML file, the agent modifying the call payload based on the XML file.

23. The non-transitory computer readable storage medium of claim 15, wherein the identification is received in a file generated in response to user input, the file generated from the user input.

24. The non-transitory computer readable storage medium of claim 23, wherein input is received through a user interface.

25. A non-transitory computer readable storage medium having embodied thereon a program, the program being executable by a processor to perform a method for monitoring a business transaction, the method comprising:
receiving a call from a remote application;
determining that the call matches configuration data;
retrieving a monitoring parameter from an identified portion of the call; and
processing the call with the monitoring parameter.

26. The non-transitory computer readable storage medium of claim 25, wherein the identified portion is an expandable portion.

27. The non-transitory computer readable storage medium of claim 25, wherein the portion includes a payload property.

28. The non-transitory computer readable storage medium of claim 25, wherein the portion includes an existing map payload.

29. A system for monitoring a business transaction, comprising:
a processor;
a memory; and
one or more modules stored in memory and executable by a processor to receive an identification of an portion of a payload to be transmitted from a first application to a second application, automatically modify by an agent a call from the first application to include a monitoring parameter in the identified portion of the payload and transmit the call with the monitoring parameter.

30. The system of claim 29, wherein the identified portion is an expandable portion.

31. The system of claim 29, wherein the receiving an identification includes receiving a method identifier.

32. The system of claim 29, wherein the received identification identifies a payload.

33. The system of claim 29, wherein the portion includes a payload property.

34. The system of claim 29, wherein the portion includes an existing map payload.

35. The system of claim 29, the method further comprising instrumenting byte code of the application to insert code which detects the call that is modified.

36. The system of claim 29, wherein the identification is stored in an XML file, the agent modifying the call payload based on the XML file.

37. The system of claim 29, wherein the identification is received in a file generated in response to user input, the file generated from the user input.

38. The system of claim 37, wherein input is received through a user interface.

39. A system for monitoring a business transaction, comprising:
a processor;
a memory; and
one or more modules stored in memory and executable by a processor to receive a call from a remote application, determine that the call matches configuration data, retrieve a monitoring parameter from an identified portion of the call, and process the call with the monitoring parameter.

40. The system of claim 39, wherein the identified portion is an expandable portion.

41. The system of claim 39, wherein the portion includes a payload property.

42. The system of claim 39, wherein the portion includes an existing map payload.
